(19) United States
(12) Patent Application Publication
(10) Pub. No.: US 2026/0118842 A1
(43) Pub. Date: Apr. 30, 2026

(54) ADAPTIVE SENSOR OPERATION ADJUSTMENT FOR CONTENT GENERATION

(71) Applicant: INTERNATIONAL BUSINESS MACHINES CORPORATION, Armonk, NY (US)

(72) Inventors: Alecio Pedro Delazari Binotto, Munich (DE); Jose Luis Spagnuolo Sobrinho, Alpharetta, GA (US); Fernando Luiz Koch, Palm Beach Gardens, FL (US); Francis Powlesland, Munich (DE)

(21) Appl. No.: 18/931,944

(22) Filed: Oct. 30, 2024

(51) Int. Cl. G05B 13/04

(52) U.S. Cl. CPC G05B 13/048; G05B 13/042

(57) ABSTRACT

Systems, methods of and computer program products for optimizing operation parameters of sensors measuring data used by at least one generative model are described herein. A method for optimizing operation parameters of sensors measuring data used by a generative model may comprise reading historical environment information; reading sensor data as it measured by at least one sensor of the plurality of sensors; identifying at least one change to an environment; predicting a user input to the generative model; generating a current usage ranking of the plurality of sensors; identifying optimized values for operation parameters for each of the plurality of sensors in accordance with the at least one change, the predicted user input, and/or the current usage ranking; and adjusting at least one operation parameter in accordance with the one or more optimized values.

### BACKGROUND

Embodiments of the present disclosure relate to generative models, and more specifically, to optimizing operation parameters of sensors measuring data used by at least one generative model.

### BRIEF SUMMARY

According to embodiments of the present disclosure, systems, methods of and computer program products for optimizing operation parameters of sensors measuring data used by at least one generative model are provided. A method for optimizing operation parameters of sensors measuring data used by at least one generative model may comprise reading historical environment information. The historical environment information may comprise prior sensor data collected by a plurality of sensors and prior user input to at least one generative model. The method may comprise reading sensor data as it measured by at least one sensor of the plurality of sensors.

The method may comprise identifying at least one change to an environment of the plurality of sensors. The identification may be based on the sensor data and the historical environment information. The method may comprise predicting a user input to the at least one generative model. The prediction may be based on a current state of the environment and the historical environment information. The method may comprise generating a current usage ranking of the plurality of sensors based on usage of each of the plurality of sensors by the at least one generative model and the sensor data.

The method may comprise identifying optimized values for operation parameters for each of the plurality of sensors in accordance with the at least one change, the predicted user input, and/or the current usage ranking. The method may comprise adjusting at least one operation parameter in accordance with the one or more optimized values.

### BRIEF DESCRIPTION OF THE DRAWINGS

FIG. 1 is a flow diagram depicting an exemplary method for optimizing operation parameters of sensors measuring data used by at least one generative model, in accordance with one or more embodiments of this disclosure.

FIG. 2 illustrates an exemplary system for optimizing operation parameters of sensors measuring data used by at least one generative model, in accordance with one or more embodiments of the present disclosure.

FIG. 3 is a flow diagram depicting an exemplary method for generating content by at least one generative model, in accordance with one or more embodiments of this disclosure.

FIG. 4 is a flow diagram depicting an exemplary method for optimizing operation parameters of sensors measuring data used by at least one generative model, in accordance with one or more embodiments of this disclosure.

FIG. 5 is a flow diagram depicting an exemplary method for optimizing operation parameters of sensors measuring data used by at least one generative model, in accordance with one or more embodiments of this disclosure.

FIG. 6 is a flow diagram depicting an exemplary method for optimizing operation parameters of sensors measuring data used by at least one generative model, in accordance with one or more embodiments of this disclosure.

FIG. 7 depicts a computing node according to one or more embodiments of the present disclosure.

### DETAILED DESCRIPTION

Content is commonly presented to passengers of vehicles (e.g., airliners, trains, buses, and other multi-user environments). For example, instructional vehicles are presented to passengers at various parts of a journey in a vehicle. Such content is not generally customized to each user. As a result, the content may be ignored. Additionally, other content may need to be generated for current situations. For example, a warning may be issued to a passenger after fire is detected outside the vehicle. Current on-board sensor platforms lack the flexibility to adjust sensor operations in real-time to cater to dynamic changes in the environment and the specific demands of users. The systems and methods described herein preemptively adjust sensor operations to cater to dynamic changes in the environment and the specific demands of users. Additionally, the systems and methods described herein enable real-time adjustment of operation parameters to further account for the dynamic changes. The adjustments of sensor operations described herein enable real-time generation of content customized for individual users.

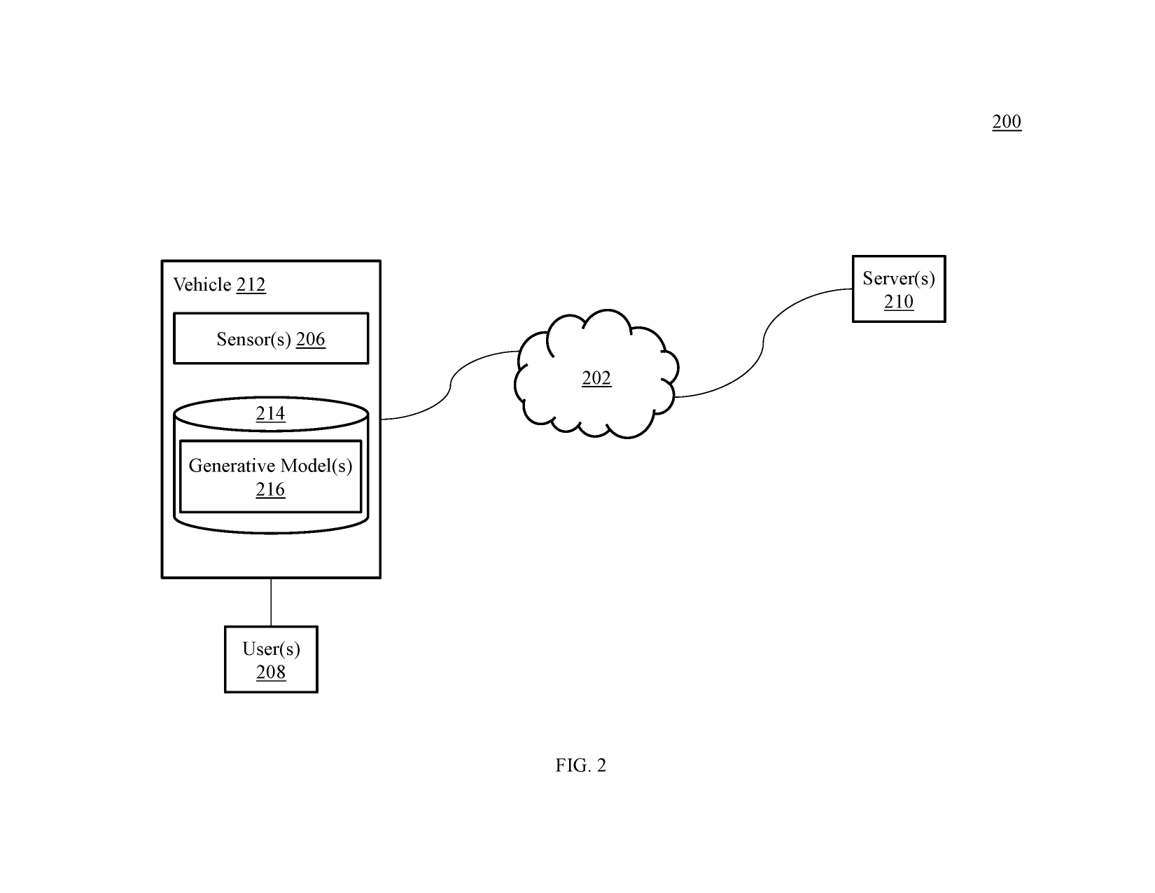

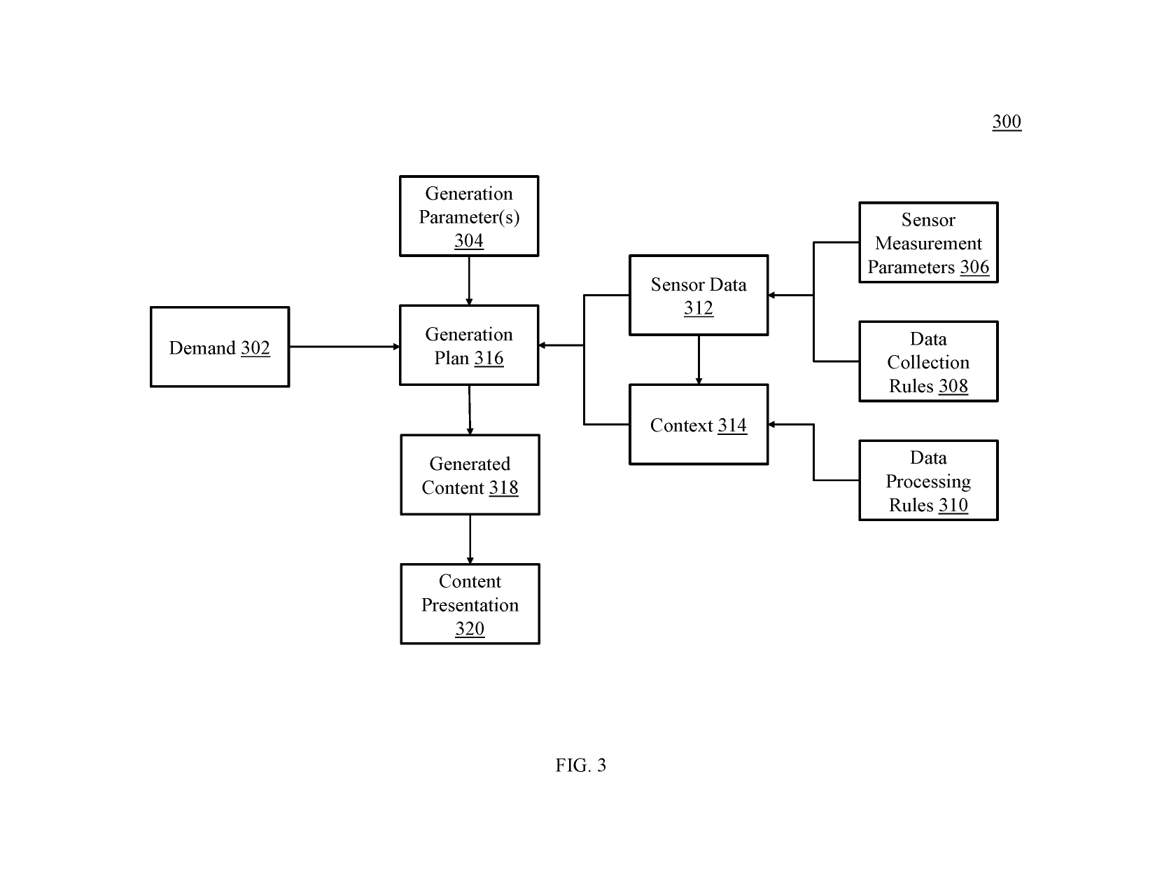

FIG. 3 is a flowchart illustrating an exemplary method 300 for generating content by at least one machine learning model, in accordance with one or more embodiments of the present disclosure. Method 300 may comprise reading demand 302. Demand 302 may comprise an indication of a request for information. Demand 302 may have been provided by one or more users (e.g., user(s) 208 depicted in FIG. 2 and described herein) via a user interface. Method 300 may comprise measuring sensor data 312. Sensor data 312 may be measured by one or more sensors (e.g., sensor(s) 206 depicted in FIG. 2). Sensor operation parameters characterizing operation of the sensors and/or processing of sensor data may comprise sensor measurement parameters 306, data collection rules 308, and data processing rules 310. Sensor data 312 may be measured in accordance with sensor measurement parameters 306, and/or data collection rules 308. Sensor measurement parameters 306 may comprise one or more of a sampling rate of a sensor, a sensitivity level of a sensor, a resolution, a range of values, data processing parameters, and/or other sensor operation parameters. A resolution may indicate a minimum unit of change to a measured value that can be registered and measured by a sensor. A range of values may indicate a minimum and a maximum value capable of being measured by a sensor. Data collection rules 308 may comprise a set of rules for identifying information to be used by the one or more generative models responsive to the query. For example, data collection rules 308 comprise a set of rules for identifying one or more sensors measuring data pertinent to the query. Method 300 may comprise reading sensor data 312. Method 300 may comprise storing sensor data 312 in storage 214 (depicted in FIG. 2 and described herein) and/or another storage media. Sensor data 312 may be read and/or stored in accordance with data collection rules 308. In some implementations, sensor data 312 is stored remotely from vehicle 212 (depicted in FIG. 2 and described herein).

Method 300 may comprise generating context 314 based on sensor data 312, data processing rules 310, and/or other information. Data processing rules 310 may comprise a set of rules for generating context 314 based on sensor data 312. For example, context 314 is generated by a rule-based algorithm, a machine learning model, and/or another algorithm. The rule-based algorithm may be designed in accordance with data processing rules 310.

Context 314 may characterize the current state of a vehicle (e.g., vehicle 212 depicted in FIG. 2 and described herein). Context 314 may characterize emotional context of the one or more users, environmental context, and/or other information. The emotional context of the one or more users may identify a predicted current emotion of the one or more users. The emotional context of the one or more users may be determined based on one or more physiological parameters of the one or more users, eye moment of the one or more users, a facial expression of the one or more users, a current activity of the one or more users, brain wave analysis of the one or more users, and/or other information. For example, the current activity indicates that at least one user is talking. For example, the emotional context of a user who is fidgeting and has a high heart rate may identify that the user is predicted to be anxious.

The environmental context may characterize a state of an area directly external to the vehicle. The environmental context may comprise vehicle context. For example, the environmental context indicates that there is a fire outside of the vehicle. The vehicle context may characterize a state of the interior of the vehicle and/or a state of the vehicle including the exterior and interior. For example, the vehicle context indicates that the vehicle has recently been involved in an accident. The vehicle context may further indicate the severity of the accident. For example, the vehicle context may characterize a current time, a current location of the vehicle, a current destination for the vehicle, and/or other information pertaining to the vehicle.

One or more generative models and/or another system (e.g., an algorithm) may generate a generation plan 316. The generative model(s) may comprise one or more machine learning models. Generation plan 316 may be generated automatically, manually, or semi-automatically. Generation plan 316 may be generated based on demand 302, one or more generation parameters 304, sensor data 312, context 314, and/or other information. Generation parameter(s) 304 may characterize one or more topics for generation, a target audience of generated information, one or more templates for generated information, and/or other information. Generation plan 316 may indicate one or more resources required for generation of information responsive to demand 302. In some implementations, method 300 comprises determining whether the requested information is capable of being generated locally. In such implementations, generation plan 316 comprises an indication whether to generate the information locally or offload the generation to a remote engine.

Method 300 may comprise generating generated content 318 in accordance with demand 302, sensor data 312, context 314, generation plan 316, and/or other information. For example, generated content 318 comprises information requested by the one or more users as characterized by demand 302. The one or more generative models may generate generated content 318. Sensor data 312 and/or context 314 may have been used by one or more generative models for generating generated content 318. For example, sensor data 312 and/or context 314 provide a factual basis for generated content 318. Method 300 may comprise presenting generated content 318 as content presentation 320. Content presentation 320 may be an audio and/or a visual presentation. For example, content presentation 320 comprises a spoken representation of generated content 318 presented via one or more speakers of the vehicle. Content presentation 320 may comprise a visual representation (e.g., text and/or graphics) presented via a screen within the vehicle.

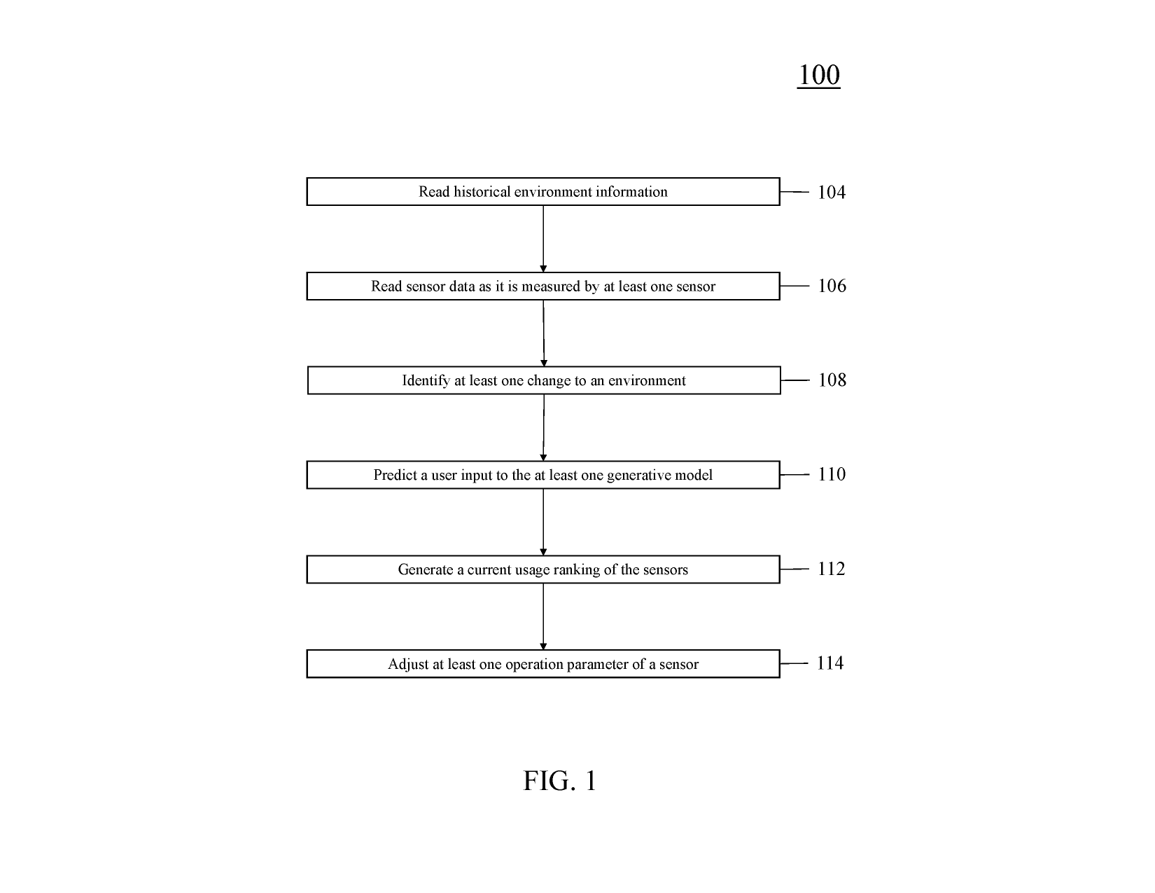

FIG. 1 is a flowchart illustrating an exemplary method 100 for optimizing operation parameters of sensors measuring data used by at least one generative model. The operations of method 100 presented below are intended to be illustrative. In some implementations, method 100 is accomplished with one or more additional operations not described and/or without one or more of the operations discussed. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise reading historical environment information. The historical environment information may characterize previous states of an environment. For example, the environment may comprise a vehicle and a region surrounding the vehicle. The historical environment information may comprise prior sensor data collected by a plurality of sensors and prior user input to at least one generative model. The historical environment information may comprise sensor data, demands, and/or other information. Each data point of the prior sensor data may have an associated time indicating when the data point was measured. Each demand may have an associated time indicating when the demand was read. The demand may have been determined by one or more generative models configured to generate information in accordance with demands. Demands may be explicit and/or implicit. Explicit demands may be characterized by queries. Determining a demand may comprise reading a query provided by a user. Implicit demands may be characterized by emotions of user(s), behavioral characteristic(s), a current state of the environment, and/or another parameter. The associated time for each data point and/or for each demand may be a local time of the environment.

Operation 104 may comprise reading sensor data as it measured by at least one sensor of the plurality of sensors. For example, sensors within the environment continuously measure information characterizing the environment. Each data point of the sensor data may have an associated time indicating when the data point was measured. For example, the sensor data is read in real time.

Operation 106 may comprise identifying at least one change to an environment of the plurality of sensors. The identification may be based on the sensor data and the historical environment information. The at least one change may be a change in behavior of a user, a change in a demand, a change in usage of a sensor, a change in a current state of the environment, and/or another change. The current state of the environment may comprise the environmental context of the environment at a current point in time and/or over a period of time that includes the current point in time.

Operation 108 may comprise predicting a demand for the at least one generative model. Predicting the demand may comprise predicting a user input to a user input of the environment. The user input may characterize a query. The prediction may be based on a current state of the environment and the historical environment information. For example, the current state of the environment may be characterized by a local time at the environment, a temperature surrounding the environment, a temperature within the environment (e.g., within the vehicle where the environment comprises a vehicle), current sensor data, and/or other information. Current sensor data may be data measured by the one or more sensors during a period of time. The period of time may end at the present moment. The period of time may comprise the minute prior to the present, one or more seconds prior to the present, and/or another unit of time prior to the present. In some implementations, the temperature surrounding the environment is measured by a sensor of the environment. In some implementations, the temperature surrounding the environment is measured by a sensor that is separate from the environment. For example, the temperature may be sampled from a weather database.

Operation 110 may comprise generating a current usage ranking of the plurality of sensors based on usage of each of the plurality of sensors by the at least one generative model and the sensor data. The usage of each sensor may be predicted and/or may be an actual current usage. For example, the sensors may be ranked in order of contribution to the content generation process for current demands. A sensor measuring information used by the one or more generative models to respond to a demand may contribute to the content generation for the demand. At least one sensor may contribute to the content generation for a demand. Different sensors contributing to a demand may have different levels of contribution to the content generation for a demand. For example, one sensor may contribute to the content generation for a demand more than the other sensors contributing to the content generation contributing to the content generation for that demand. A sensor contributing more to the content generation for a particular demand than another sensor may be by virtue of the sensor measuring information more pertinent to the information generated. The sensors may be ranked in accordance with quantities of current demands to which each sensor contributes to the content generation process, a level of contribution to each of the current demands, and/or other information.

Operation 112 may comprise identifying optimized values for operation parameters for each of the plurality of sensors in accordance with the at least one change, the predicted demand, and/or the current usage ranking. The optimized values may minimize storage used for storing sensor data, minimize the amount of sensor data for processing during content generation, minimize energy requirements for sensor data collection, and/or enable other optimizations.

Operation 114 may comprise adjusting at least one operation parameter in accordance with the one or more optimized values. Adjusting the at least one operation parameter may comprise transmitting a signal to one or more signals. The one or more signals may instruct the one or more sensors to update sensor operation parameters in accordance with the one or more optimized values. Adjusting the at least one operation parameter may comprise adjusting one or more parameters of a processor configured to store and/or process sensor data in non-transitory storage.

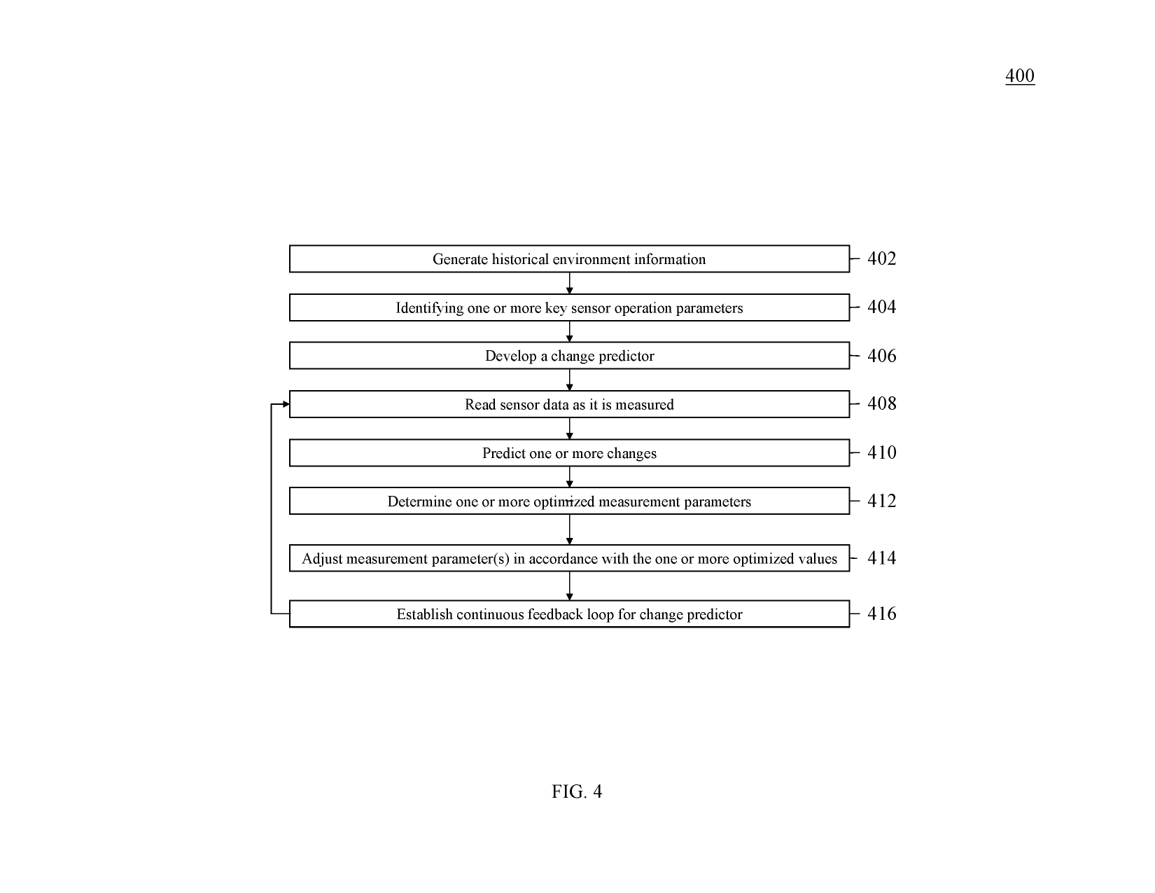

Referring to FIG. 4, a flowchart illustrating an exemplary method 400 for optimizing operation parameters of sensors measuring data used by at least one generative model is depicted. The operations of method 400 presented below are intended to be illustrative. In some implementations, method 400 is accomplished with one or more additional operations not described and/or without one or more of the operations discussed. Additionally, the order in which the operations of method 400 are illustrated in FIG. 4 and described below is not intended to be limiting.

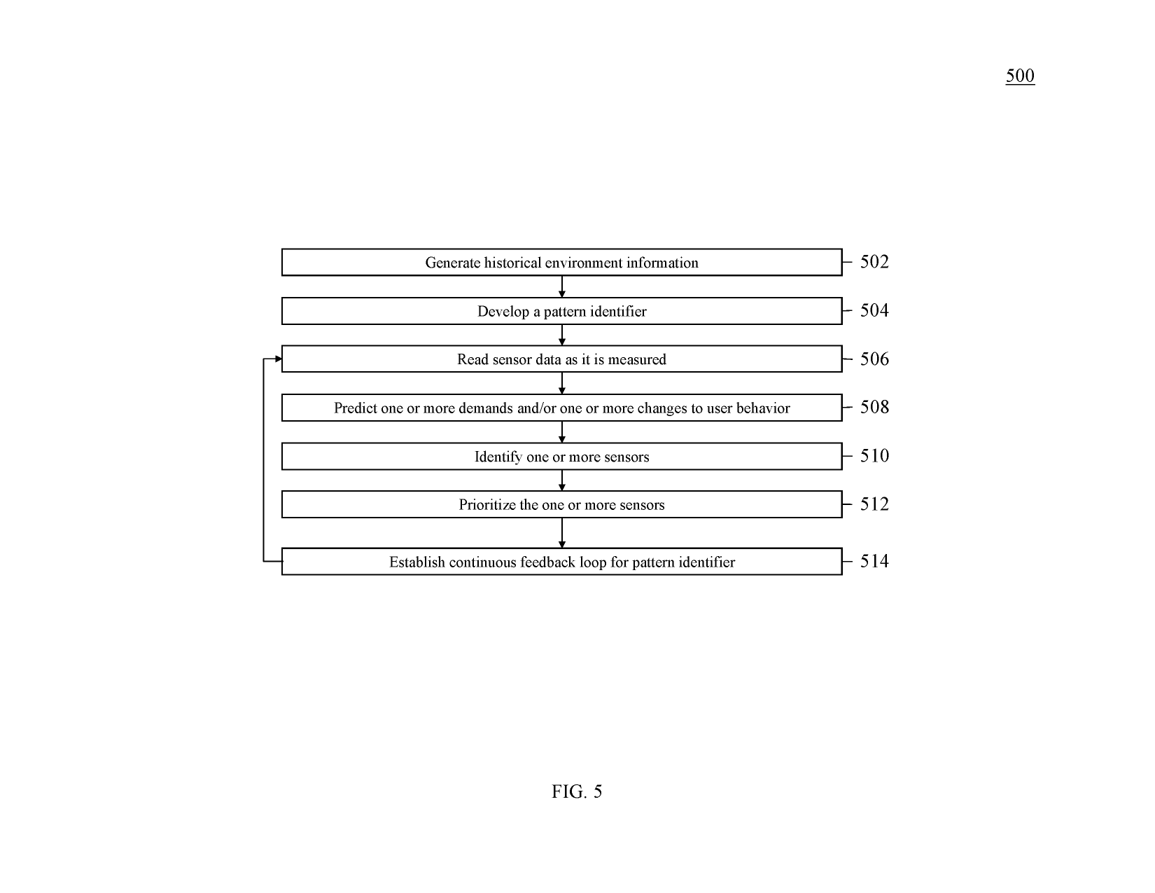

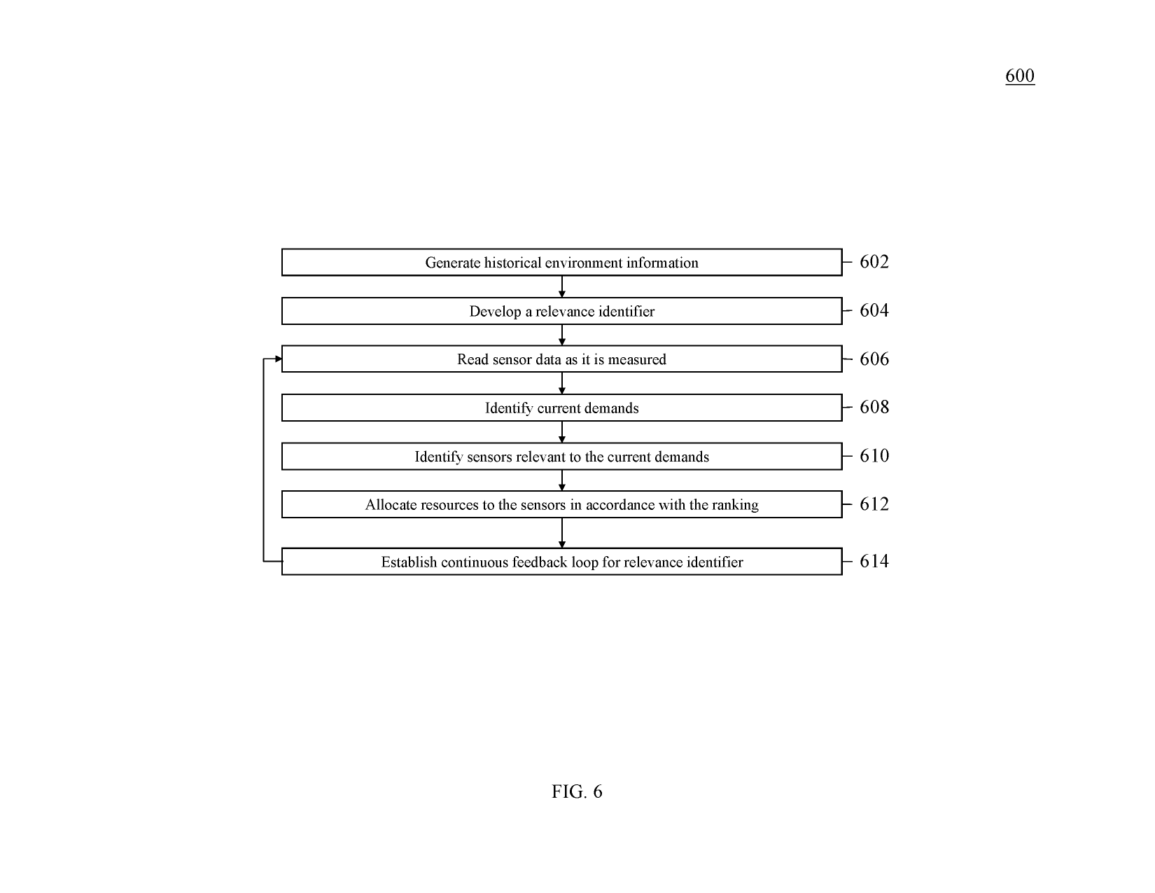

In some implementations, method 400 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 400. Method 400 may be performed in conjunction with, prior to, after, in parallel with, and/or as part of any combination of one or more of method 100 depicted in FIG. 1, method 500 depicted in FIG. 5, and/or method 600 depicted in FIG. 6.

Operation 402 may comprise generating historical environment information. Generating the historical environment information may comprise historical sensor data. Generating the historical environment may comprise reading and storing sensor data. Generating the historical environment information may comprise reading and storing user input provided via one or more user interfaces and/or to a microphone. Generating the historical environment information may comprise reading and storing information generated responsive to demands. Generating the historical environment information may comprise reading and storing information characterizing user preferences. The sensor data, the user input, the generated information, and/or the user preferences may be read and stored over a window of one or more weeks, one or more months, one or more days, and/or another unit of time.

Operation 404 may comprise identifying one or more key sensor operation parameters. The key sensor parameter(s) may comprise sensor operation parameters affecting contribution of one or more sensors to the content generation for demands. For example, the one or more key sensor operation parameters are identified in accordance with the historical sensor data.

Operation 406 may comprise developing a change predictor. The change predictor may be configured to predict changes in an environment, user behavior, and/or user demands. Demands may comprise requests and/or needs of the users. The change predictor may comprise one or more of a rule-based algorithm, an artificial intelligence algorithm, a machine learning model, and/or another computer-implemented algorithm. For example, a machine learning model of the change predictor is trained using the historical environment information. The change predictor may be developed manually, automatically, and/or semi-automatically. For example, a machine learning model is trained automatically. The change predictor may be configured to receive sensor data as input.

Operation 408 may comprise reading sensor data as it is measured by at least one sensor of the plurality of sensors. Operation 408 may be the same as or part of operation 104 depicted in FIG. 1. For example, operation 104 comprises operation 408.

Operation 410 may comprise predicting one or more changes using the change predictor. Predicting the one or more changes may comprise providing sensor data as input to the change predictor. The sensor data may be provided as input as it is read. The sensor data may be provided to the change predictor at designated time increments. For example, every 5 seconds, the sensor data read for the past 5 seconds is provided as input to the change predictor. Predicting the one or more changes may comprise read output from the change predictor. The output may characterize one or more predicted changes to the environment. The one or more changes may be predicted in accordance the sensor data. For example, the one or more changes characterize one or more changes in trends and/or to the individual points of the sensor data. For example, a predicted change may indicate an emotion of a user has changed, a fire has started, a direction of the environment has changed, a crash has occurred, or another change to the environment. Operation 410 may be the same as or part of operation 106 depicted in FIG. 1. For example, operation 106 comprises operation 410.

Operation 412 may comprise determining one or more optimized measurement parameters. The optimized measurement parameters may be the same as or similar to sensor measurement parameters 306. The optimized measurement parameters may be determined based on the one or more predicted changes. The optimized measurement parameters may be determined by the change predictor and/or another computer-implemented algorithm. The measurement parameters may comprise sensor operation parameters particularly regarding how the one or more sensors measure sensor data. For example, the measurement parameters may comprise a measurement sensitivity, a sampling rate, a resolution, a range of values, and/or other sensor operation parameters. For example, sampling rates for temperature sensors may be increased based on the predicted change(s) indicating a fire has started. Operation 412 may be the same as or part of operation 112 depicted in FIG. 1. For example, operation 112 comprises operation 412.

Operation 414 may comprise adjusting at least one measurement parameter in accordance with the one or more optimized values. Adjusting the at least one measurement parameter may comprise transmitting a signal to one or more signals. The one or more signals may instruct the one or more sensors to update measurement parameters in accordance with the one or more optimized values. Operation 412 may be the same as or part of operation 114 depicted in FIG. 1. For example, operation 114 comprises operation 412.

Operation 416 may comprise establishing a continuous feedback loop to monitor effectiveness of sensor adjustments. Establishing the continuous feedback loop may comprise refining the rules of the rule-based algorithms and/or adjusting the models in accordance with assessed and expected results. Establishing the continuous feedback loop may comprise determining a level of accuracy of one or more actual changes to the environment and the one or more predicted changes to the environment. The change predictor may be updated in accordance with the level of accuracy.

FIG. 5 is a flowchart illustrating an exemplary method 500 for optimizing operation parameters of sensors measuring data used by at least one generative model. The operations of method 500 presented below are intended to be illustrative. In some implementations, method 500 is accomplished with one or more additional operations not described and/or without one or more of the operations discussed. Additionally, the order in which the operations of method 500 are illustrated in FIG. 5 and described below is not intended to be limiting.

In some implementations, method 500 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 500. Method 500 may be performed in conjunction with, prior to, after, in parallel with, and/or as part of any combination of one or more of method 500 depicted in FIG. 1, method 400 depicted in FIG. 4, and/or method 600 depicted in FIG. 6.

Operation 502 may comprise generating historical environment information. Generating the historical environment information may comprise historical sensor data. Generating the historical environment may comprise reading and storing sensor data. Generating the historical environment information may comprise reading and storing user input provided via one or more user interfaces and/or to a microphone. Generating the historical environment information may comprise reading and storing information generated responsive to demands. Generating the historical environment information may comprise reading and storing information characterizing user preferences. The sensor data, the user input, the generated information, and/or the user preferences may be read and stored over a window of one or more weeks, one or more months, one or more days, and/or another unit of time. Operation 502 may be the same as or similar to operation 402 depicted in FIG. 4.

Operation 504 may comprise developing a pattern identifier. The pattern identifier may be configured to identify one or more patterns of the sensor data and/or relevance of the one or more patterns to upcoming demands and/or user behaviors. The pattern identifier may comprise one or more machine learning models and/or another computer-implemented algorithm. The pattern identifier may be configured to identify one or more patterns of historical sensor data relevant to one or more historical demands and/or user behaviors. For example, the patterns characterize a trend of sensor data measured by one or more sensors over a period of time leading up to the demands and/or the user behaviors. Identifying the one or more current patterns may enable prediction of a demand, prediction of sensor data pertinent to content generation for the predicted demand, and/or prediction of a sensor measuring data pertinent to the content generation.

Developing the pattern identifier may comprise training a machine learning model using the historical information. Sensor data may be provided as input to the one or more machine learning models and/or another computer-implemented algorithm. The pattern identifier may be configured to predict user behaviors and/or demands responsive to the input. For example, the pattern identifier is configured to predict user input. The pattern identifier may identify one or more patterns inherent in the input to predict the user behaviors and/or demands. The one or more patterns may be identified implicitly by one or more machine learning models of the pattern identifier.

Operation 506 may comprise reading sensor data as it measured by at least one sensor of the plurality of sensors. Operation 506 may be the same as or part of operation 104 depicted in FIG. 1 and/or operation 408 depicted in FIG. 4. For example, operation 104 comprises operation 506.

Operation 508 may comprise predicting one or more demands and/or one or more changes to user behavior. The prediction may comprise providing the sensor data and other current information as input to the pattern machine learning model. The prediction may comprise reading one or more demands and/or one or more changes predicted by the pattern identifier. Operation 508 may be the same as or part of operation 108 depicted in FIG. 1. For example, operation 108 comprises operation 504. Operation 508 may be the same as or part of operation 108 depicted in FIG. 1. For example, operation 108 comprises operation 508.

Operation 510 may comprise identifying one or more sensors measuring information likely to be used by the one or more generative models. The one or more sensors may be identified based on the one or more demands and/or the one or more changes to user behavior. In some implementations, the one or more sensors may be identified by the pattern identifier and/or another computer-implemented algorithm. Operation 510 may be the same as or part of operation 112 depicted in FIG. 1. For example, operation 112 comprises operation 510.

Operation 512 may comprise prioritizing the one or more sensors. Prioritizing a sensor may comprise adjusting one or more sensor measurement parameters of the sensor (e.g., sensor measurement parameters 306 depicted in FIG. 3), one or more data collection parameters for the sensor (e.g., data collection rules 308 depicted in FIG. 3), and/or one or more data processing rules (e.g., data processing rules 310 depicted in FIG. 3). For example, prioritizing a sensor may comprise increasing the sampling rate of the sensor. For example, prioritizing a sensor may comprise providing sensor data measured by the sensor to the one or more generative models. Operation 512 may be the same as or part of operation 114 depicted in FIG. 1. For example, operation 114 comprises operation 512.

Operation 514 may comprise establishing a continuous feedback loop to monitor effectiveness of the pattern identifier. The feedback loop may be configured to compare the prioritized sensors to the sensors measuring information used by the one or more generative models. For example, if a prioritized sensor is not measuring information used by the one or more generative models for content generation, the pattern identifier may have generated an incorrect prediction. An indication of the incorrect prediction may be provided to the pattern identifier. Indications of correct predictions may also be provided to the pattern identifier. The pattern identifier may be updated in accordance with the indications of incorrect and correct predictions.

FIG. 6 is a flowchart illustrating an exemplary method 600 for optimizing operation parameters of sensors measuring data used by at least one generative model. The operations of method 600 presented below are intended to be illustrative. In some implementations, method 600 is accomplished with one or more additional operations not described and/or without one or more of the operations discussed. Additionally, the order in which the operations of method 600 are illustrated in FIG. 6 and described below is not intended to be limiting.

In some implementations, method 600 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 600. Method 600 may be performed in conjunction with, prior to, after, in parallel with, and/or as part of any combination of one or more of method 100 depicted in FIG. 1, method 400 depicted in FIG. 4, and/or method 500 depicted in FIG. 5.

Operation 602 may comprise generating historical environment information. Generating the historical environment information may comprise historical sensor data. Generating the historical environment may comprise reading and storing sensor data. Generating the historical environment information may comprise reading and storing user input provided via one or more user interfaces and/or to a microphone. Generating the historical environment information may comprise reading and storing information generated responsive to demands. Generating the historical environment information may comprise reading and storing information characterizing user preferences. The sensor data, the user input, the generated information, and/or the user preferences may be read and stored over a window of one or more weeks, one or more months, one or more days, and/or another unit of time. Operation 602 may be the same as or similar to operation 402 depicted in FIG. 4 and/or operation 502 depicted in FIG. 5.

Operation 604 may comprise developing a relevance identifier. The relevance identifier may be configured to generate a ranking of sensors. The ranking of the sensors may be based on usage of each of the plurality of sensors by the at least one generative model and the sensor data. The pattern identifier may comprise one or more machine learning models and/or another computer-implemented algorithm. Developing the pattern identifier may comprise training a machine learning model using the historical information. Demands may be provided as input to the one or more machine learning models and/or another computer-implemented algorithm. In some implementations, the relevance identifier may be configured to generate a current ranking of the sensors based on current demands, historical information, and/or other information.

Operation 606 may comprise reading sensor data as it measured by at least one sensor of the plurality of sensors. Operation 606 may be the same as or part of operation 104 depicted in FIG. 1 and/or operation 408 depicted in FIG. 4. For example, operation 104 comprises operation 506.

Operation 608 may comprise identifying current demands. Identifying the current demands may comprise reading user input characterizing a query. Identifying the current demands may comprise identifying one or more current demands based on sensor data. Operation 608 may be the same as or part of operation 110 depicted in FIG. 1. For example, operation 110 comprises operation 608.

Operation 610 may comprise identifying sensors relevant to the current demands based on the current demands. Identifying the relevant sensors may comprise providing the current demands as input to the relevance identifier. Identifying the relevant sensors may comprise reading a generated ranking of the sensors generated by the relevance identifier. The relevant sensors may be identified in accordance with the ranking. For example, the ranking may be continuously updated and/or generated in accordance with current sensor data. Operation 610 may be the same as or part of operation 110 depicted in FIG. 1. For example, operation 110 comprises operation 610.

Operation 612 may comprise allocating resources to the sensors in accordance with the ranking. Allocating resources to the sensors may comprise adjusting one or more sensor measurement parameters (e.g., sensor measurement parameters 306 depicted in FIG. 3), one or more data collection parameters for the sensor (e.g., data collection rules 308 depicted in FIG. 3), and/or one or more data processing rules (e.g., data processing rules 310 depicted in FIG. 3). For example, the resources comprise bandwidth allocated to processing sensor data measured by relevant sensors, storage allocated to sensor data measured by relevant sensors, memory allocated to sensor data measured by relevant sensors, energy allocated to operation of relevant sensors, and/or other parameters. Operation 612 may be the same as or part of operation 112 depicted in FIG. 1. For example, operation 112 comprises operation 612.

Operation 614 may comprise establishing a continuous feedback loop to monitor effectiveness of the relevance identifier. The feedback loop may be configured to compare the identified relevant sensors to the sensors measuring information used by the one or more generative models responsive to a current demand. For example, the feedback loop may be configured to identify one or more sensors measuring information that were used by the one or more generative models responsive to a current demand and that were not identified as relevant. An indication of incorrect sensor rankings may be provided to the relevance identifier. Indications of correct sensor rankings may also be provided to the pattern identifier. The pattern identifier may be updated in accordance with the indications of incorrect and correct rankings.

FIG. 2 illustrates an exemplary system 200 for optimizing operation parameters of sensors measuring data used by at least one generative model, in accordance with one or more embodiments of the present disclosure. System 200 may comprise a vehicle 212, a network 202, and one or more servers 210. Vehicle 212 may be configured to communicate with server(s) 210 via network 202. By way of non-limiting example, vehicle 212 comprises one or more computing devices. For example, vehicle 212 is an airplane, a train, a car, a bus, a truck, a semi-truck, a boat, a golf cart, and/or another type of vehicle. Vehicle 212 may comprise one or more sensors 206, storage 214, and/or other components.

Sensor(s) 214 may be disposed external to and/or within vehicle 212. Sensor(s) 214 may comprise one or more of a camera, a motion sensor, a temperature sensor (e.g., a thermocouple or a thermometer), a sensor measuring one or more physiological parameters of one or more users (e.g., user(s) 208 depicted in FIG. 2 and described herein), a depth sensor, a microphone, a heart rate monitor, and/or other sensors. The physiological parameter(s) may comprise one of more of heart rate, blood pressure, body temperature, breathing rate, blood oxygen saturation, glucose level, skin hydration level, skin quality, and/or another quantifiable indicator of bodily function. For example, storage 214 may be non-transitory electronic storage. In some implementations, storage 214 is part of and/or operatively connected to the one or more computing devices of vehicle 212. Storage 214 may be configured to store one or more generative models 216.

One or more users 208 may interact with vehicle 212. For example, user(s) 208 may be passenger(s) in and/or driver(s) of vehicle 212. User(s) 208 may provide input to vehicle 212 via one or more user interfaces or controls of vehicle 212. The input may characterize a query to be provided as input to one or more generative models (e.g., generative model(s) 216 and/or one or more other generative models). The one or more generative models may be configured to generate information responsive to receipt of the query as input. The information may be generated by one or more generative models 216 locally (e.g., within vehicle 212). Server(s) 210 may store one or more generative models. The one or more generative models of server(s) 210 may be used to generate information for one or more users 208 remotely from vehicle 212. In some implementations, some information is generated locally and some information is generated remotely. In some implementations, all information generated responsive to queries from user(s) 208 are generated locally or remotely. By way of non-limiting example, information may be generated remotely due to limited resources being available on vehicle 212.

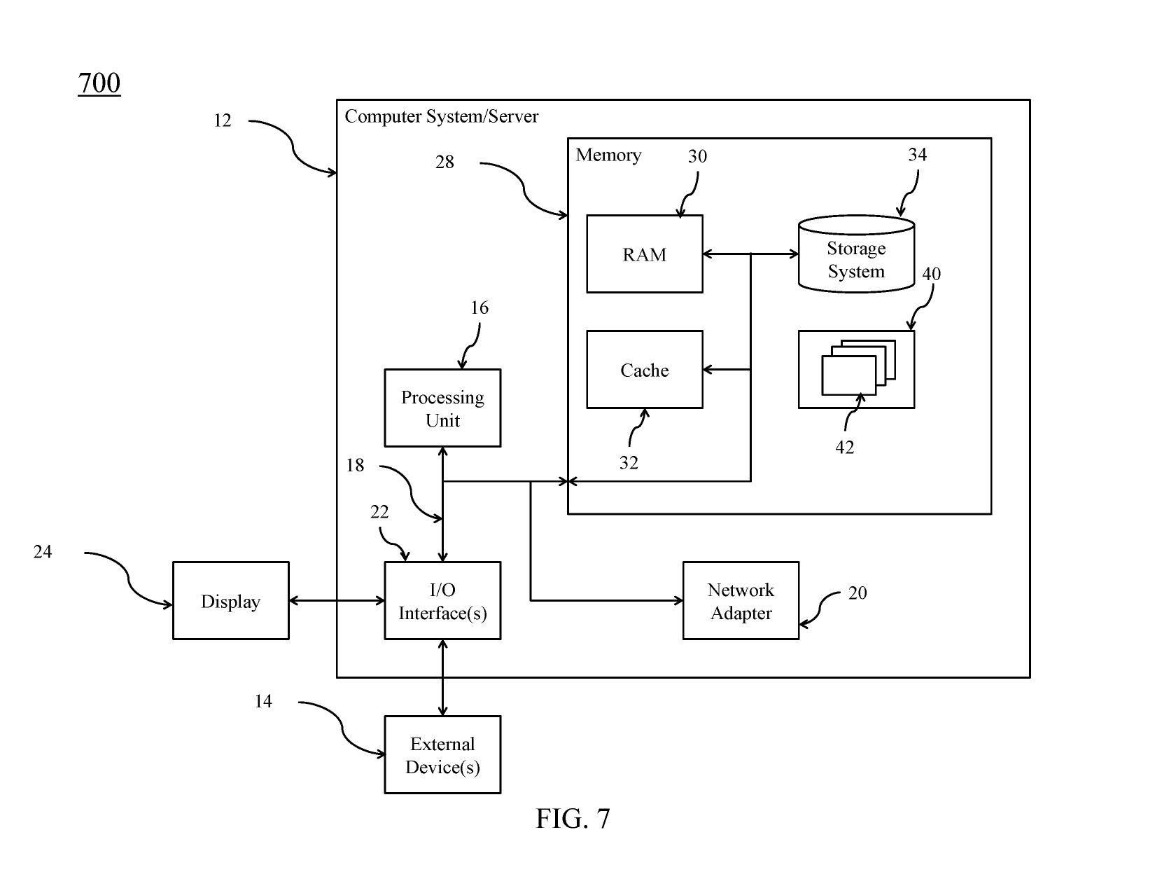

Referring now to FIG. 7, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In various embodiments, a vector of features that includes the machine learning model input(s) may be provided to one or more of the machine learning models described herein. Based on the input features, one or more of the machine learning models described herein may generate one or more outputs. In some embodiments, the output(s) of the one or more machine learning models described herein may be a vector of features.

In various embodiments, the one or more machine learning models, described herein, may be pre-trained using training data. In various embodiments, training data may be retrospective data. In various embodiments, the retrospective data may be stored in a datastore. In various embodiments, the one or more machine learning models, described herein, may be additionally trained through manual curation of previously generated outputs.

In various embodiments, the one or more machine learning models, described herein, may be and/or may include a dynamic programming algorithm and/or model, such as a dynamic linear programming algorithm/model or a dynamic nonlinear programming algorithm/model. In various embodiments, the one or more machine learning models, described herein, may be a trained classifier. In various embodiments, the trained classifier may be a random decision forest. However, it will be appreciated that a variety of other classifiers are suitable for use according to the present disclosure, including linear classifiers, support vector machines (SVM), or artificial neural network models, such as generative adversarial networks (GANs) and/or recurrent neural networks (RNNs).

Suitable artificial neural network models include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

In various embodiments, the one or more machine learning models described herein may be trained using health data as described herein and/or data available from public and/or private databases and/or data stores. For example, the machine learning model(s) may be trained to determine a health risk to the individual based on in situ data, such as real-time in situ data. As another example, the machine learning model(s) may be trained to determine an individualized treatment and a response score corresponding to the individualized treatment. The response score may indicate an effectiveness of the individualized treatment.

Although the systems and methods are described herein primarily with reference to being implemented, at least in part, on a vehicle, this is not intended to be limiting. In alternative implementations, the systems and methods described herein may be implemented on or using any other computing system. For example, a room or another environment may be used in place of a vehicle. For example, a personal computer and/or another computing system may be used instead of a computing device located within a vehicle.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing operation parameters of sensors, the method comprising:
reading historical environment information, the historical environment information comprising prior sensor data collected by a plurality of sensors and prior user input to at least one generative model;
reading sensor data as it is measured by at least one sensor of the plurality of sensors;
identifying, based on the sensor data and the historical environment information, at least one change to an environment of the plurality of sensors;
predicting, based on a current state of the environment and the historical environment information, a user input to the at least one generative model;
generating a current usage ranking of the plurality of sensors based on usage of each of the plurality of sensors by the at least one generative model and the sensor data;
identifying optimized values for operation parameters for each of the plurality of sensors in accordance with the at least one change, the predicted user input, and the current usage ranking; and
adjusting at least one operation parameter in accordance with the one or more optimized values.

2. The method of claim 1, wherein the prior sensor data is generated by:
continuously reading the prior sensor data as it is collected by the plurality of sensors during a period of time, and
storing the prior sensor data.

3. The method of claim 1, wherein the at least one change is identified by a change model, wherein the change model is configured to identify changes to the environment responsive to receiving sensor data measured within the environment as input, the method further comprising:
training the change model using the historical environment information; and
updating, using a continuous feedback loop, the change model in accordance with current environment information.

4. The method of claim 1, wherein the user input to the at least one generative model characterizes a query, wherein the user input is predicted by a prediction model, wherein the prediction model is configured to predict a query responsive to receiving information characterizing a current state of the environment as input, the method further comprising:
training the prediction model using the historical environment information; and
updating, using a continuous feedback loop, the prediction model in accordance with current environment information.

5. The method of claim 1, wherein the current usage ranking is generated by a ranking model, wherein the ranking model is configured to determine usage rankings responsive to receiving sensor data measured within the environment as input method further comprising:
training the ranking model using the historical environment information; and
updating, using a continuous feedback loop, the ranking model in accordance with current environment information.

6. The method of claim 1, wherein the environment comprises a vehicle.

7. The method of claim 1, wherein the current usage ranking is continuously updated in accordance with the sensor data.

8. The method of claim 1, wherein identifying the optimized values comprises:
selecting one or more of the plurality of sensors measuring sensor data likely to be used by the at least one generative model.

9. The method of claim 1, wherein adjusting at least one operation parameter comprises:
transmitting, to a first sensor of the plurality of sensors, a signal indicating an optimized value for the at least one operation parameter.

10. The method of claim 1, wherein the operation parameters comprise a sensitivity level and a sampling frequency.

11. The method of claim 1, wherein the plurality of sensors comprises at least one sensor measuring characteristics of a user physically located in the environment.

12. A computer program product comprising:
one or more computer-readable storage media; and
program instructions stored on the one or more computer-readable storage media to perform operations comprising:
reading historical environment information, the historical environment information comprising prior sensor data collected by a plurality of sensors and prior user input to at least one generative model;
reading sensor data as it is measured by at least one sensor of the plurality of sensors;
identifying, based on the sensor data and the historical environment information, at least one change to an environment of the plurality of sensors;
predicting, based on a current state of the environment and the historical environment information, a user input to the at least one generative model;
generating a current usage ranking of the plurality of sensors based on usage of each of the plurality of sensors by the at least one generative model and the sensor data;
identifying optimized values for operation parameters for each of the plurality of sensors in accordance with the at least one change, the predicted user input, and the current usage ranking; and
adjusting at least one operation parameter in accordance with the one or more optimized values.

13. The computer program product of claim 12, wherein the at least one change is identified by a change model, wherein the change model is configured to identify changes to the environment responsive to receiving sensor data measured within the environment as input, the method further comprising:
training the change model using the historical environment information; and
updating, using a continuous feedback loop, the change model in accordance with current environment information.

14. The computer program product of claim 12, wherein the user input to the at least one generative model characterizes a query, wherein the user input is predicted by a prediction model, wherein the prediction model is configured to predict a query responsive to receiving information characterizing a current state of the environment as input, the method further comprising:
training the prediction model using the historical environment information; and
updating, using a continuous feedback loop, the prediction model in accordance with current environment information.

15. The computer program product of claim 12, wherein the current usage ranking is generated by a ranking model, wherein the ranking model is configured to determine usage rankings responsive to receiving sensor data measured within the environment as input method further comprising:
training the ranking model using the historical environment information; and
updating, using a continuous feedback loop, the ranking model in accordance with current environment information.

16. The method of claim 1, wherein identifying the optimized values comprises:
selecting one or more of the plurality of sensors measuring sensor data likely to be used by the at least one generative model.

17. A computer system comprising:
a processor set;
one or more computer-readable storage media; and
program instructions stored on the one or more computer-readable storage media to perform operations comprising:
reading historical environment information, the historical environment information comprising prior sensor data collected by a plurality of sensors and prior user input to at least one generative model;
reading sensor data as it is measured by at least one sensor of the plurality of sensors;
identifying, based on the sensor data and the historical environment information, at least one change to an environment of the plurality of sensors;
predicting, based on a current state of the environment and the historical environment information, a user input to the at least one generative model;
generating a current usage ranking of the plurality of sensors based on usage of each of the plurality of sensors by the at least one generative model and the sensor data;
identifying optimized values for operation parameters for each of the plurality of sensors in accordance with the at least one change, the predicted user input, and the current usage ranking; and
adjusting at least one operation parameter in accordance with the one or more optimized values.

18. The computer system of claim 16, wherein the at least one change is identified by a change model, wherein the change model is configured to identify changes to the environment responsive to receiving sensor data measured within the environment as input, the method further comprising:
training the change model using the historical environment information; and
updating, using a continuous feedback loop, the change model in accordance with current environment information.

19. The computer system of claim 16, wherein the user input to the at least one generative model characterizes a query, wherein the user input is predicted by a prediction model, wherein the prediction model is configured to predict a query responsive to receiving information characterizing a current state of the environment as input, the method further comprising:
training the prediction model using the historical environment information; and
updating, using a continuous feedback loop, the prediction model in accordance with current environment information.

20. The computer system of claim 16, wherein the current usage ranking is generated by a ranking model, wherein the ranking model is configured to determine usage rankings responsive to receiving sensor data measured within the environment as input method further comprising:
training the ranking model using the historical environment information; and
updating, using a continuous feedback loop, the ranking model in accordance with current environment information.
